(19) United States
(12) Patent Application Publication
(10) Pub. No.: US 2003/0217287 A1
(43) Pub. Date: Nov. 20, 2003

(54) Secure desktop environment for unsophisticated computer users

(76) Inventor: Ilya Kruglenko, Alicante (ES)

Correspondence Address: BIRCH STEWART KOLASCH & BIRCH, PO BOX 747, FALLS CHURCH, VA, 22040-0747, US

(21) Appl. No.: 10/437,293

(22) Filed: May 14, 2003

Related U.S. Application Data
(60) Provisional application No. 60/383,576, filed on May 29, 2002.

(30) Foreign Application Priority Data
May 16, 2002 (NO) 2002-2376

(51) Int. Cl. H04L 9/00

(52) U.S. Cl. 713/200

(57) ABSTRACT

The invention presents a method for preventing an unsophisticated user, such as a small child, from access programs or resources on a computer that may allow the user to cause harm to the computer system. This is done by limiting access to the computer's resources to a number of predefined secure programs and resources.

First, a number of predefined keystrokes or keystrokes combinations are disabled as input from a keyboard or similar input device in order to prevent input that starts or interacts with insecure programs or accesses insecure resources. In addition, user interaction with insecure programs or resources is prevented by making all windows associated with already running programs incapable of receiving input from user input devices, preferably by hiding them so they cannot appear on the computer screen. The user is then presented with a secure user interface, said interface presenting the user with representations of computer programs and resources that are defined as secure.

### BACKGROUND OF THE INVENTION

The present invention relates to a system for limiting unsophisticated users' access to the resources of a computer. Particularly, the invention relates to a method, a computer system and computer software products for preventing children or other unsophisticated users from accessing anything but predefined resources on a computer system.

A wide range of solutions have been provided in order to prevent unauthorized users from accessing resources on computer systems. These measures range from peripheral protection from external users by such means as firewalls and encryption, to protection from inadvertent or malicious acts by users that have authorized access to the computer system, but not to all resources available on the system. The latter is usually implemented by defining ownership of files, folders and other resources, and limiting the access users have to resources that are not their own, in accordance with a given system policy.

Such means may give adequate security in a professional environment where all users are fairly sophisticated, and where time and resources available for administration of the system are sufficient. However, these measures are inadequate for users of home computers where a number of family members use the same computer, where resources and skills for administrating the system and defining user privileges are limited, and where the users that it is most important to restrict namely young children—are unsophisticated and with limited need for computer resources.

When children are using a family computer they are acting as any other user. Even if a parent (main user or administrator) creates a special account with low privileges for the child, the child will still be able to run applications (even potentially harmful ones), browse the file system and delete files, and make other system wide adjustments. When a parent returns to the computer and logs on, he or she may find out that files are missing or that some devices are not working properly, and often it is very difficult or even impossible, to get things back in order. Even if children are working on their own computers they may, when unsupervised, upset the system in a manner that even if no important data is lost, requires substantial effort in order to bring the system back in working condition.

The challenge is to create an environment that allows children to interact with the computer, but only allows access to predefined resources. Specifically, an unsophisticated user should be prevented from browsing the file system and deleting or modifying any files that do not belong to this user, change system settings, and start any applications that are not specifically allowed by a main user (administrator).

A number of approaches are available for solving this problem. It is possible to limit access to certain files or folders only, either by using passwords to control the access to each particular file or folder, or to allow access depending on which user is currently logged in on the system.

However, the traditional approach of defining user privileges and access rights requires a lot of skill from the administrator, and there is a high risk that the average parent will lack the necessary skill to set up adequate rights and restrictions for a child. This approach is a lot more flexible and sophisticated than what the situation requires. After all, the child is not a skilled but malicious user trying to circumvent security measures, but an unsophisticated user that acts out of curiosity and lack of skill, and may create damage to the computer inadvertently.

U.S. Pat. No. 5,809,230 presents a method for controlling access to computer system resources. The method includes the use of a stored user identifier and a list of computer resources for each user of the computer system and displaying only the computer resources in the list corresponding to the user identifier for the currently active user. The method is based on preventing unauthorized initialization to the system and access control for the various resources.

Unauthorized initialization is prevented through relocation of the original master boot record and the original partition table on the computer hard disk and providing a corrupted master boot record and a corrupted partition table in the original location, making it impossible for a program using the corrupted versions to initialize the system. Initialization of the program is then performed using a security protection program that is able to access the original boot record and partition table to be restored.

The access control is based on intercepting service calls. Using files with a list of authorized resources for the user, the interrupt service calls are verified to determine whether the user is authorized for the resource requested in the service call. The files are used at system initialization to modify the system resource files used by the operating system to identify program and program groups displayed to a user.

The method necessitates fairly sophisticated administrative skills by the main user and requires a wide number of decisions to be made for each user of the computer system. Also, the technical implementation results in modifications to such fundamental parts of the computer system as the master boot record and the partition table.

### SUMMARY OF THE INVENTION

The present invention aims at creating a secure user environment wherein a user's access to computer resources is predefined in a manner that drastically limits the user's potential to do harm through carelessness or lack of skill. The invention does not primarily aim at preventing a sophisticated user from accessing resources, and it may therefore be circumvented by a person with knowledge of computers unless it is accompanied by other measures for preventing unauthorized access from skilled users.

The approach of the present invention is not to try to protect specific resources by restricting access to these resources. Instead, each program is seen as the user's way of communicating with the system. Programs are considered to be either secure or insecure. Secure programs are primarily programs that do not give the user any access to features that can harm the system or change it in a potentially undesirable manner. Insecure programs, on the other hand, are not sufficiently restricted in this way. As an example, programs like Notepad and Paint, that are delivered as part of the standard Windows® installation from Microsoft Corp., are considered insecure because the Open and Save commands give access to the entire file system, including system files. Windows is a registered trademark of Microsoft Corporation.

According to the invention, a secure environment is created in the following manner. First, all keyboard input is monitored on the system level in order to disable system hotkeys and other keystrokes that may be used to access insecure programs or features. Secondly, all user interaction with already running programs by on screen windows by using keyboard commands or a pointing device, such as a mouse, is disabled. This can preferably be done by hiding all windows that belong to programs that are already running when the secure environment is started, so that they can not appear on the computer screen. Since system hotkeys have been disabled, it is impossible to use hotkeys to launch new programs, change focus to hidden windows etc. And since the windows are hidden and will remain hidden, it will be impossible to interact with the corresponding programs by using a mouse or similar device. This window hiding functionality is supplemented by an alert service that handles windows that are about to be launched after the secure environment has been started in a similar manner. When the protected mode implemented by the invention is terminated, program windows that were hidden are returned to their initial location and status and all hotkeys are unlocked.

In addition to implementing these measures, a secure user interface is started. Through this secure environment the user will only be allowed to access programs that are defined as secure and that are listed in a secure programs list.

According to a preferred embodiment of the invention, an administrator, such as a parent, will be able to add additional programs to this list. Such additions may potentially compromise the security of the environment through the addition of programs that are insecure, but this can be done in a manner that corresponds with the child's development as a computer user.

The secure desktop environment is preferably designed to function very much like a regular graphical user interface. The security is mainly taken care of by the following functionality. All running programs are monitored. Since a user can only start programs through the desktop environment, the user will only be able to start programs that are explicitly defined as secure in a list of secure programs. If any other program should start, e.g. as a result of a scheduled backup or virus scan, an event triggered by one of the running programs that were hidden during secure mode initiation, or by any other mean, the desktop environment program will treat this program as insecure. This situation can be handled in a number of ways. According to a preferred embodiment, the desktop program will issue a message requesting the attention of an administrator (parent), and suspend the program and/or hide program windows until an administrator takes action by entering a password.

The secure user environment can preferably be configured by an administrator who is allowed to add programs to the list of secure programs, or set user rights to access certain resources such as printing or other resources after entering a password.

The invention as claimed includes a method for limiting access to a computers resources as well as a computer system programmed to perform the method according to the invention. The invention may be implemented as computer program code instructions that enables a computer to operate according to the invented method when installed on a such a computer.

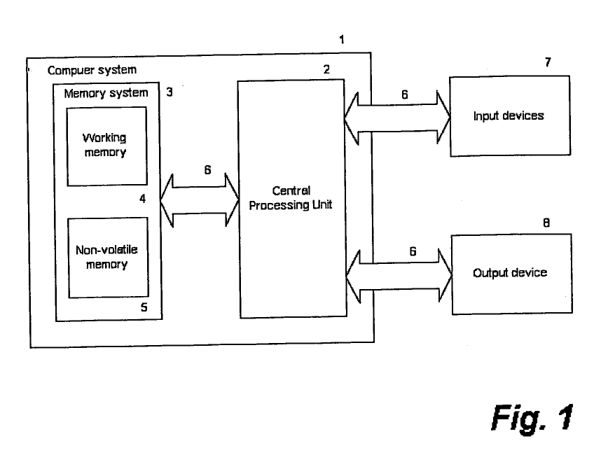

FIG. 1 shows a block diagram of a computer system;

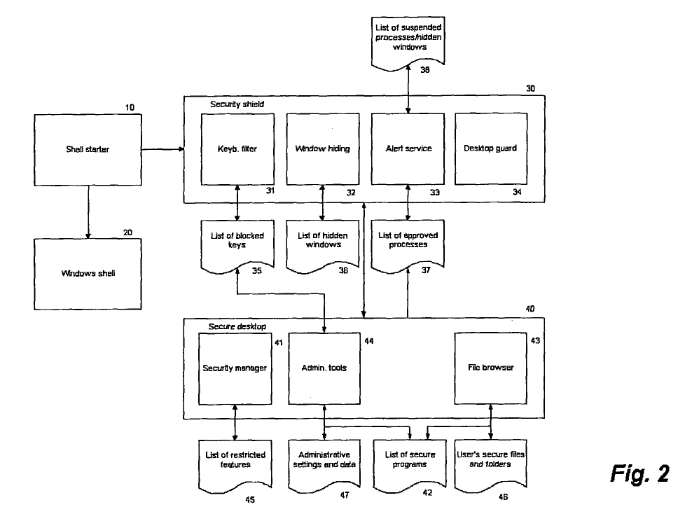

FIG. 2 shows a block diagram illustrating the main components of one implementation of the invention;

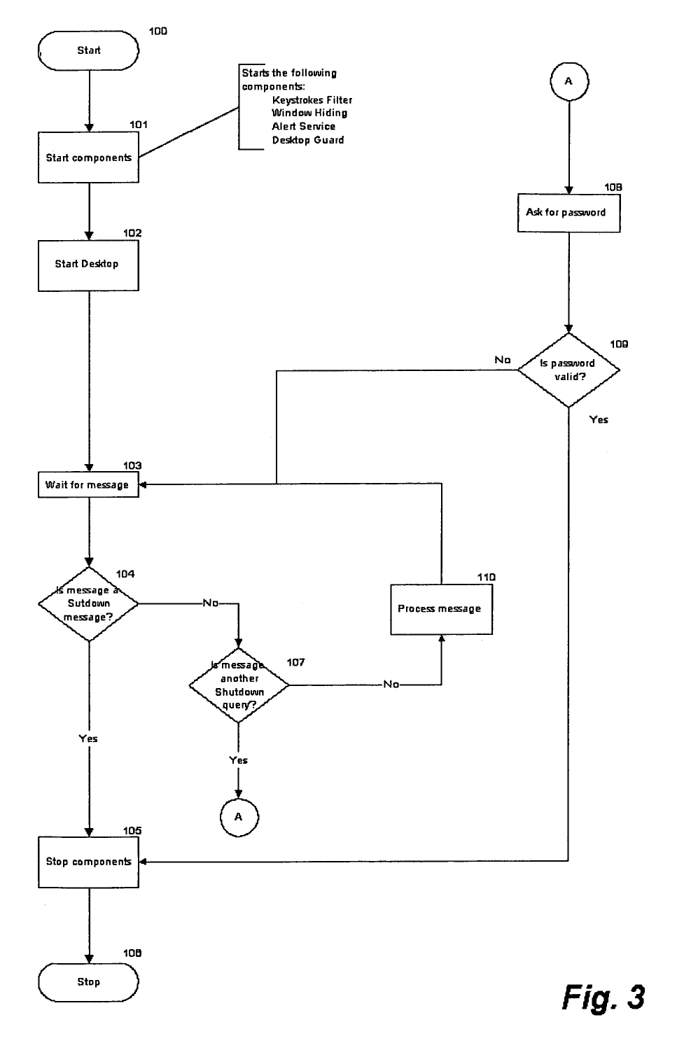

FIG. 3 illustrates in a flow chart, the general operation of the security shield;

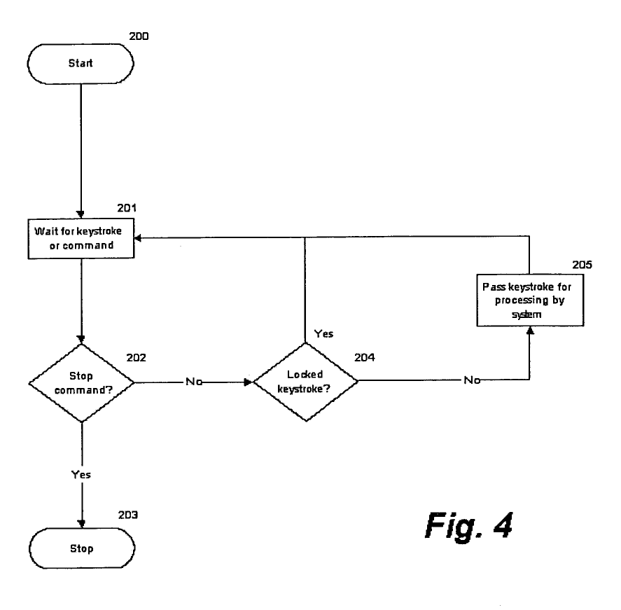

FIG. 4 illustrates the operation of a keystrokes filter;

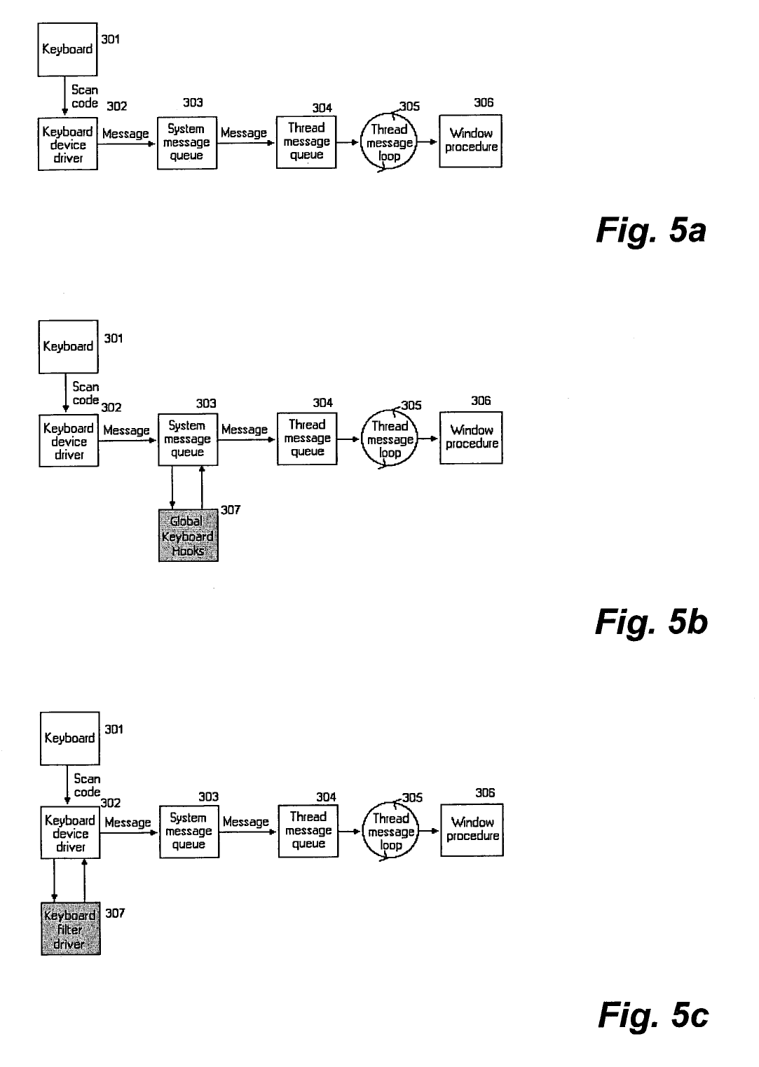

FIG. 5a illustrates the keyboard input model of a Windows system;

FIG. 5b illustrates the keyboard input model with global keyboard hooks installed;

FIG. 5c illustrates the keyboard input model with driver filter installed;

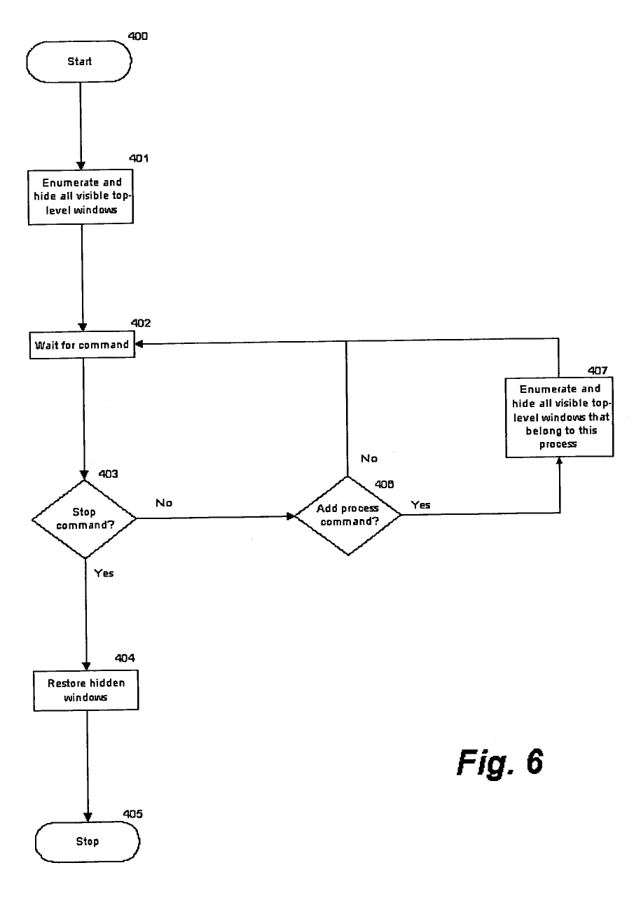

FIG. 6 illustrates in a flowchart, the operation of a windows hiding module;

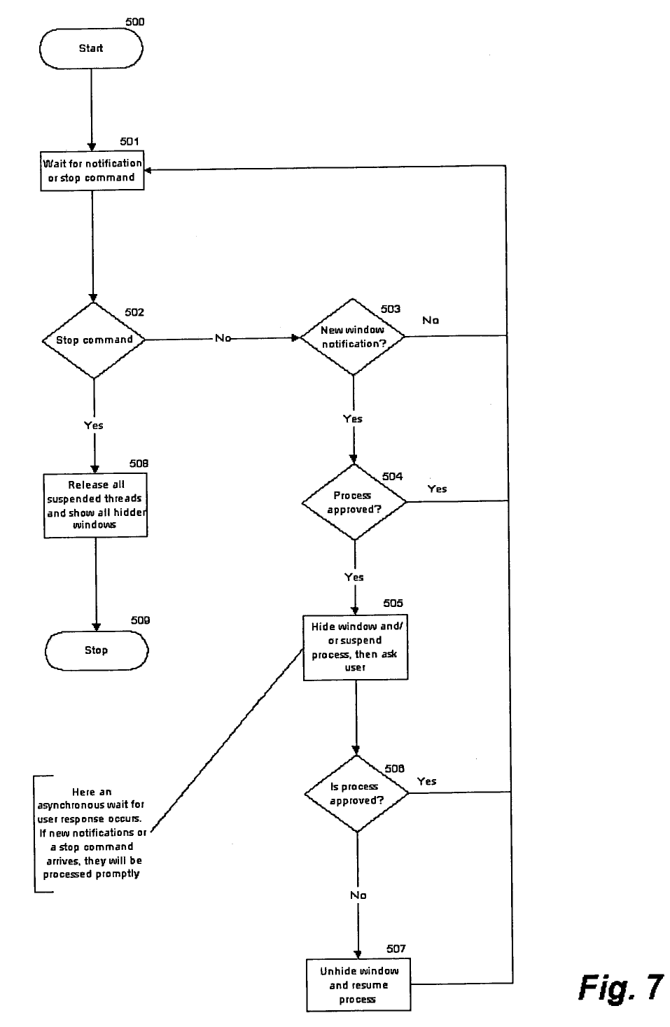

FIG. 7 shows a flowchart for an alert service monitoring and reacting to indications that a new window is about to open;

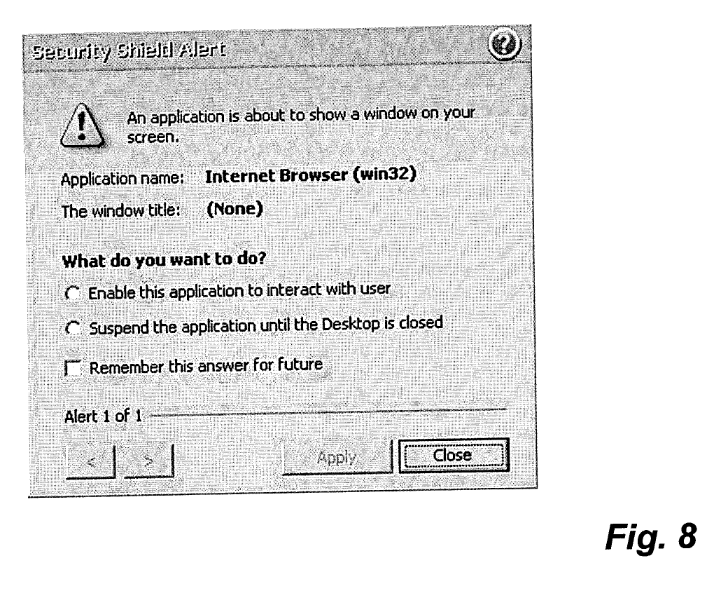

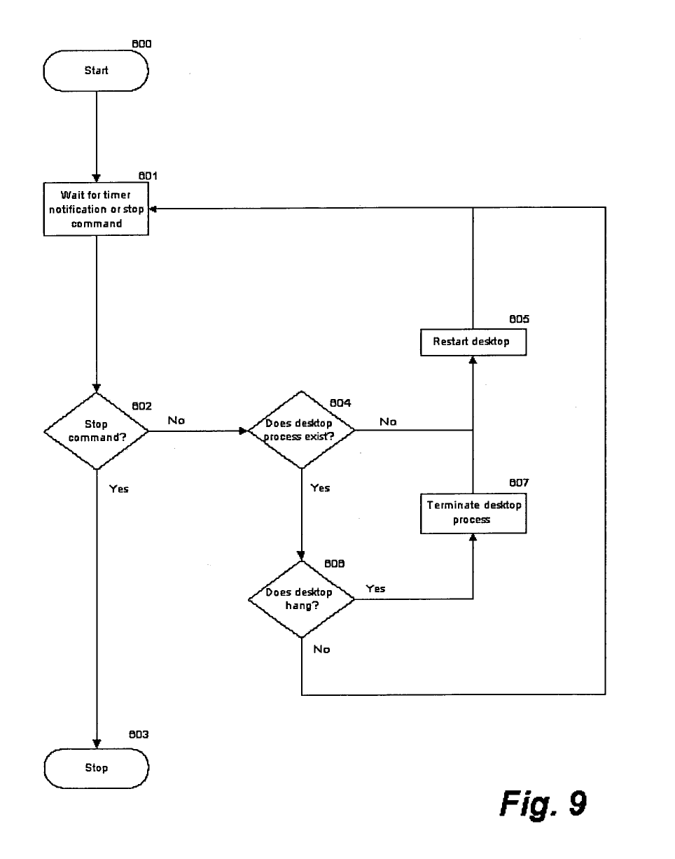

FIG. 8 shows a screen shot illustrating an alert from the alert service;

FIG. 9 is a flowchart illustrating the functionality of a desktop guard;

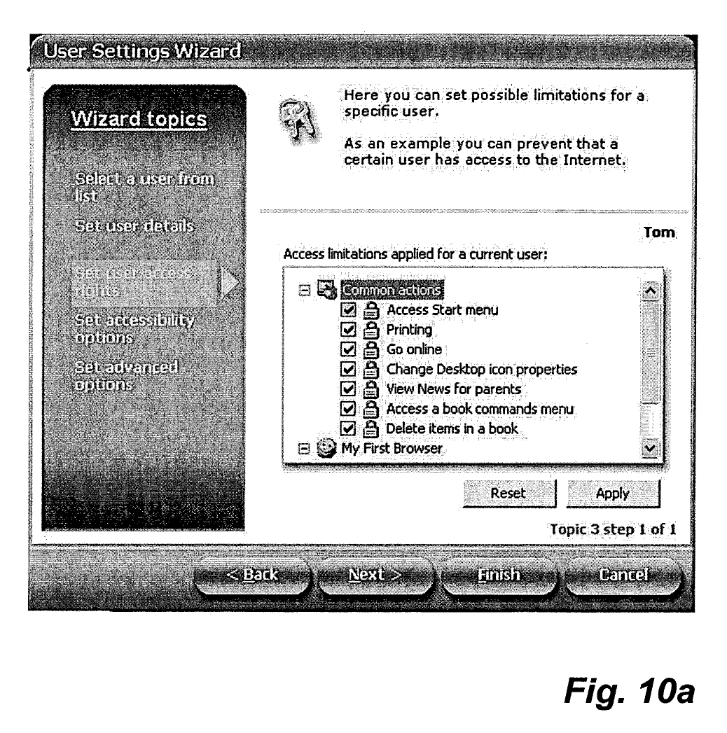

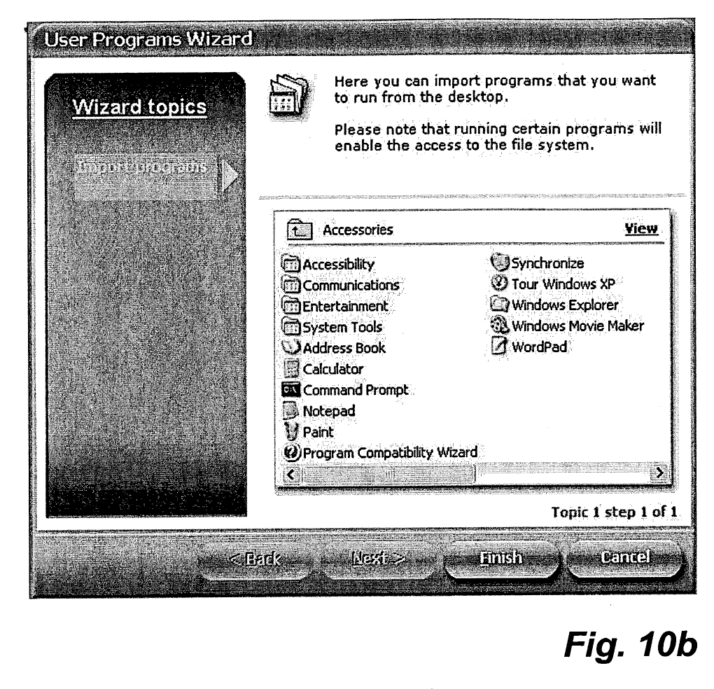

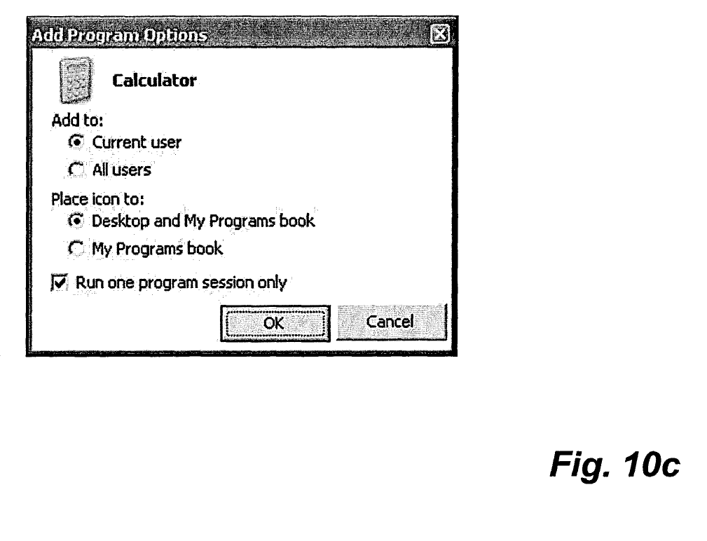

FIGS. 10a-c show screen shots illustrating examples of administrator tool dialog boxes.

The invention will now be described in further detail by way of an example. The example will mainly describe the invention when it is operated on a computer using one of the well known operating systems of the Windows family from Microsoft Corp. However, a skilled person will realize that it will be possible to implement the principles and ideas set forth herein on computers using other operating systems without abandoning the scope and spirit of the invention as presented in the attached claims.

FIG. 1 shows a general block diagram of a computer system on which the invention may be worked. The computer system includes a personal computer 1 with at least one central processing unit 2 and a memory system. The CPU may have any of a variety of architectures, but in the following example it will be assumed to be a processor of the x86 family from a manufacturer such as Intel or AMD. The memory system includes at least a high speed working memory 4, where data and program instructions may be stored and accessed by the processor during the operation of the system, and a non-volatile memory 5 for long term storage of data. The working memory will typically comprise random access memory (RAM) circuits and read only circuits (ROM). The non-volatile memory may be in the form of hard disks, floppy disks, CD-ROM etc. The various units of the personal computer communicate with each other using one or more data bus structures 6.

A user of the computer system interacts with the system using input devices 7 such as a keyboard, a mouse or other pointing device etc. The system also includes an output device 8 that may include a display device such as a computer screen and possibly other output devices such as speakers etc.

The operating system in a computer serves as a layer between the hardware of the computer and the various application programs installed on the system and makes it possible for the applications to exchange data with the hardware and with each other. In a Windows type environment the various components and modules, such as the ones described below, may communicate with each other and with other applications as well as with the operating system using a number of inter-process communication means, such as Windows Messages, clipboard, COM, Dynamic Data Exchange (DDE), file mapping, mailslots, pipes and remote procedure calls.

Application Programming Interfaces, commonly referred to as APIs, are standard system routines in Win32, which is the programming environment that enables applications to use the 32-bit instructions available in Intel 80386 processors and later. A number of standard APIs will be referred to in the following description.

It should be realized that the following examples and alternatives do not all have to be implemented in a system operating in accordance with the invention, and that many of them represent additional features that provide added convenience or security, but are not strictly necessary in order to achieve the main purpose of the invention.

The present invention is based on the realization that all user interaction with the computer system is based on the input of user commands through user interface devices such as keyboard and pointing devices such as a mouse 7. There is no way for a user to start programs or access data except through some such user interface device. The keyboard is used to enter keystrokes or keystroke combinations, while the mouse is used to interact with objects that are represented on the computer screen. User input may then be controlled by monitoring keystrokes and strictly controlling what is shown on the screen.

More sophisticated input devices, such as voice controlled commands entered through a microphone and other input devices that do not operate through keystrokes or interaction with on screen objects will may be traced and intercepted and filtered by similar means, or they may simply be disabled, as their controlling programs will be defined as insecure, as explained below.

FIG. 2 illustrates the various components in one embodiment of the invention. In order to control the user's interaction with the system and make sure that only secure programs and resources are accessed, two main features are implemented. The first is a security shield that prevents the user from reaching insecure programs or resources through input devices such as keyboard and mouse. The second is a secure desktop environment that gives the user a way of interacting with programs or resources that are defined as secure. These features may be implemented as one or more programs. In the following example three programs, or main components, will be described, representing a preferred implementation of the invention. The main components may contain additional sub-components. Other alternatives may be chosen as a matter of design choice. The three components, referred to as a shell starter 10, a security shield 30 and a secure desktop 40, are described below.

The first component of the system is a shell starter 10. The shell starter is designed to start the Windows Shell 20 and the security shield 30. The shell starter 10 is launched during user initialization immediately after a user logs on. After being launched, the shell starter 10 is designed to check the system configuration, and if it detects that the system is configured to start in secure desktop mode, it launches the security shield 30. Then it launches the windows Shell 20 and waits until the Windows Shell 20 finishes loading.

During the shell loading, the security shield 30 stays on top of other windows, so it is impossible for a user to interact with them using a pointing device. After the Windows Shell 20 has completed loading, the shell starter 10 notifies the security shield that it can continue initialization, as described below, and load the secure desktop 40, and then it terminates. If the secure environment is started manually after the Windows Shell 20 has completed loading, the shell starter 10 is not invoked, and the security shield 30 starts initialization directly.

During initialization of the secure environment, the system configuration is preferably changed in such a way that the shell starter 10 will start the system in secure mode the next time a user logs on. In this way secure mode can not be circumvented by simply turning off the computer and rebooting the system. Unless startup in secure mode is default, this system configuration will be changed back when the secure environment is terminated. The feature of temporarily changing the system configuration in this way can be implemented either in the security shield 30 or in the secure desktop component 40.

The shell starter 10 is preferably implemented as a small standalone program (exe-file). During setup it registers itself with Windows as a User Init program in Windows NT type operating systems, or as a Windows Shell in Windows 95 type operating systems.

Other implementation alternatives exist. As an example, in NT type operating systems the shell starter 10 could be implemented as an NT service so it can be started even before a user logs on. It can then be designed to control all logon and start-up processes.

Another alternative is to implement the shell starter in the same exe file as the security shield 30, and this exe file may possibly also include the secure desktop 40. However, this alternative may become unstable in case of an invalid system configuration or if other applications perform illegal operations.

The security shield 30 includes four sub-components, a keyboard filter 31, a window hiding module 32, an alert service 33 and a desktop guard 34. In addition the security shield accesses lists of blocked keys 35, hidden windows 36, approved programs and processes 37, and suspended processes and/or hidden windows 38. Reference is now made to FIG. 3, which illustrates in a flow chart the general operation of a preferred embodiment of the security shield 30. The main purpose of the security shield 30 is to launch and monitor the secure desktop 40 and to prevent unwanted user interaction with insecure programs including the operating system.

Following the start 100 of the security shield 30, its various sub-components are started 101. It should be noted that if the security shield 30 is started before the Windows Shell 20, the keyboard filter 31 is initiated before the Windows Shell 20, and the security shield stays on top of other windows by calling SetWindowPos API with HWND_TOPMOST parameter frequently, e.g. every 50 milliseconds. This ensures that the user is prevented from interacting with other programs during loading of the Windows Shell. The remaining components on the other hand, are initiated after the Windows Shell has finished loading, particularly the window hiding module 32, since there are no windows to hide until the Shell 20 has finished loading.

Next, the secure desktop 40 is started 102. After this has been done, the main component of the security shield 30 waits for messages 103. If a message is received and it turns out to be a shutdown message 104, all sub-components are stopped 105 and the security shield terminates 106. In this context a shutdown message will normally be received from the secure desktop 40 when the desktop is being turned off. If a received message is not a shutdown message, but rather some other shutdown query 107, e.g. a user attempt at shutting off the shield directly and not by entering a password in the secure desktop, the shield asks for a password 108. If the password is correct 109, the components are stopped 105 and the shield itself terminates 106. If the password is incorrect, the shield 30 continues waiting for the next message 103. If a received message is neither a shutdown message or a shutdown query, the message is processed 110, and again the shield continues to waiting for a new message 103.

The security shield 30 is preferably implemented as a small standalone program (exe file). In addition it uses a number of DLL files containing components.

Alternatively it could be implemented in the same exe file as the secure desktop. Again this could cause instability in case of invalid system configuration or illegal operations performed by other programs. Since the security shield 30 prevents normal interaction with the system, it is important that it is made as stable as possible and that the risk that this particular program will hang or in other ways act abnormally is made as small as possible.

The first sub-component of the security shield, the keyboard filter 31, is illustrated in FIG. 4. The purpose of this component is to block system wide hotkeys that can enable a user to access insecure programs and restricted system resources or features. The keyboard filter 31 traces all user input from the keyboard and “swallows” keystrokes that have been defined as illegal.

After being started 200, the keystroke filter waits for keystrokes or a stop command 201. Until it receives a stop command 202 from the security shield and stops 203, it examines all received keystrokes 204. If a received keystroke or keystroke combination is defined as locked in a list of blocked keys 35, the filter simply returns to waiting for new keystrokes or a stop command 201 without passing the keystroke or keystroke combination on. If the keystroke or keystroke combination is not locked, it is passed on to the system for processing 205 before the filter returns to waiting 201.

In order to describe the preferred implementation alternatives for the keystroke filter, reference is first made to FIG. 5a, which illustrates how keystrokes are interpreted by the system and passed to the various applications. A keyboard 301 outputs a signal called a scan code whenever a key is pressed or released. Each key is assigned a unique scan code, and the scan code for depressing and releasing a key also differs. The scan codes are device dependent, but they are interpreted by being passed to a keyboard device driver 302 to be translated to messages that include device independent virtual-key codes. These messages are placed in a system message queue 303. The system passes messages from the message queue 203 to the appropriate thread message queue 304. From the thread message queue 104, the message is removed by the thread's message loop 305 and passed to the appropriate window procedure 306.

In NT based systems (Windows NT, Windows 2000, Windows XP), the preferred implementation of the keyboard filter is based on a global low-level keyboard hook (WH_KEYBOARD_LL in a DLL file).

A hook is a point in the message-handling mechanism where the message traffic is monitored in order to intercept and process certain messages before they reach their target window procedure 306. A hook chain, which is a list of pointers to application-defined callback functions called hook procedures, is maintained for each type of hook. When a message that is associated with a hook is intercepted, the system passes the message to the hook procedure referenced in the hook chain. The action taken by the hook procedure varies between types of hooks. The message may be changed, stopped altogether, or simply monitored.

FIG. 5b illustrates how, in accordance with the invention, a global keyboard hook 307 is installed in order to intercept keystrokes. For any keystroke, the system sends a message to the hook 307 where the message is analyzed. If the keystroke is in a list 35 of locked keystrokes, the hook stops the keystroke and prevents it from reaching any procedure. If, on the other hand, the keystroke is not listed as a disabled keystroke, the message is returned to the system unchanged and eventually passed on to its proper procedure.

According to the invention, the list of locked keystrokes 35 contains all system hotkeys that may result in starting an application, change focus from one application to another (making another window the active window), or give access to system features that are protected (e.g. Alt+Tab, Ctrl+Esc, Ctrl+Alt+Del etc). Furthermore, the administrator may add any additional key or key combination to the list (e.g. Ctrl+Alt+Grey Plus, or special keys that are particular to the keyboard). This eliminates a possibility to start (or switch to) an insecure program by using the keyboard.

In order to handle the Ctrl+Alt+Del keystroke combination in NT, the system file GINA.DLL must be replaced.

As mentioned, the method described above is particularly suitable for NT versions of the Windows operating system. For earlier versions of the operating system (Windows 95, 98, Windows 3.x etc.), it is possible to create global keyboard hooks, but there may be instances where a keystroke is passed to its destination before even reaching the hook.

FIG. 5c illustrates an alternative method for these systems. This alternative is a filter driver 308 for the keyboard (e.g. a VXD file) that plugs itself into an existing keyboard driver chain. When such a driver receives an input it would either “swallow” the keystroke or transfer it to the next level in the driver chain, depending on whether the keystroke or keystroke combination is found in the list of blocked keystrokes or not.

This alternative embodiment could also be used on NT based systems instead of the global hook method described above. In 95 type systems another alternative would be to use the SystemParametersInfo API with the SPI_SCREENSAVERRUNNING parameter. In this case all system wide hotkeys will be locked at once, and it would not be possible for an administrator to leave some of the hotkeys unlocked.

Turning now to FIG. 6, the next sub-component of the security shield, the window hiding module 32, is responsible for hiding all windows that are visible when the secure environment is initiated, and restore them when the secure environment is terminated. This prevents the user from interacting with these windows using the keyboard or a pointing device. This could be done by other window interaction disabling modules, such as a module that simply disabled all windows, but then the windows would still be displayed on the screen of the display device, and it would still be necessary to hide them in some way.

After all windows have been hidden by this component, the screen will become completely blank. As soon as the windows are invisible to the user, the user cannot interact with their respective programs or services. The component responsible for hiding windows stores information necessary for restoring all hidden windows in a list of hidden windows 36, and before it terminates it uses this information to restore all hidden windows as well as any pop-up windows that would have been displayed had not the secure environment been running.

After being started 400, this sub-component of the security shield enumerates and hides all visible top-level windows 401. This can be done using the EnumWindows API and the ShowWindow or ShowWindowAsync API with the parameter SW_HIDE, respectively. The component then waits for commands 402. If it receives a command and this command is a stop command 403, all windows that have been hidden are restored 404 using the ShowWindow or ShowWindowAsync API with the parameter SW_SHOW before it terminates 405.

If a received command is not a stop command the window hiding component returns 406 to waiting for a command 402, unless the command received was an add process command 406. In this case it enumerates and hides all visible top-level windows belonging to this process 407 in the same manner as described above, before returning to waiting for another command 402.

The window hiding component is preferably implemented as a module inside the security shield executable.

An alternative way of hiding the already running programs is to provide a special hidden window and relocating all running programs to this window. The general flow of events will correspond with those described, but the methods for hiding and restoring windows differ.

In the Windows environment, certain important relationships can exist between windows. The owner-owned relationship means that when a given window is terminated, every window owned by the terminating window is also terminated. The parent-child relationship determines where a window can be drawn on the screen. A child can only be drawn inside its parent. This means that if a parent window is not shown on the screen, its children windows can not be shown either.

The special window created in accordance with this alternative embodiment of the present invention, hereinafter referred to as the parking window, is set as parent for all top-level windows that are visible when the windows hiding module is started or after the module receives an add process command 401, 407. In the Windows environment, this is done by way of the SetParent API. The parking window itself is hidden using the ShowWindow API described above.

The alternative method involving a parking window, as just described, demands that the operating system is able to handle a situation where parent and child windows do not belong to the same process or thread without creating instabilities. If this is not the case, the alternative of setting hidden attributes for each individual window is preferred.

Yet another alternative would be to let the security shield 30 create a new Windows Desktop during start-up and run the secure desktop in context of this new Windows Desktop. Then all applications that were running on any existing Windows Desktop will be isolated.

Using this approach, such services as keyboard filter 31 and desktop guard 34 would still be required.

An altogether different approach that is still within the scope of the invention, is to simply disable all windows, which means that they would still be present on the screen but incapable of receiving input from a keyboard or a pointing device.

The alert service component 33 will now be described with reference to FIG. 7. The alert service sub-component 33 of the security shield 30 is tracing situations when an insecure program running in the background is about to show a window on screen.

A number of insecure programs (programs not explicitly defined as secure) may be running simultaneously with the secure desktop environment according to the invention. Such a program could also be started by e.g. a hotkey that has not been blocked, or by a scheduler.

After starting 500, the alert service 33 traces all events indicating that a new window is created or about to become active. The alert service 33 waits for any kind of notification or stop command 501. If a received message is not a stop command 502, and not a new window notification, 503, the service returns to waiting 501. If the message is a new window notification, the alert service 33 checks, using standard APIs, which process this window belongs to 504. If the process or a program associated with this program is approved as secure according to a list of approved processes and/or programs 37, no action is taken, and the service returns to waiting 501. If, however, the process cannot be approved in this manner, the alert service 33 hides the window and/or suspends the process 505. Information identifying the hidden window and/or suspended process is stored in a list 38. Preferably, the system issues an alert on screen and prompts the user for approval of the process. If the user enters an administrator password and approves the process 506, the window is unhidden and the suspended process is resumed 507. The process and/or its associated program is entered in the alert service's list of approved processes or programs 37, either for the remainder of this session or permanently, depending on the administrators input. The user may then interact with this process. Otherwise, if the administrator keeps the process suspended until the secure environment shuts down or closes the program, the alert service 33 returns to waiting for new commands or notifications 501.

According to a preferred embodiment, the list of approved programs or processes 37 is actually two lists. A first list is kept in memory and contains identifiers of processes that have been approved during this session. A second list is stored on the systems non-volatile memory 5 as a file and is a list of programs. When the alert service checks for approval, it first checks if the relevant process has already been approved. If it has not, it checks if the program of which the process is an instantiation, can be found in the list of programs.

When the alert service 33 finally receives a stop command 502 it releases all suspended threads (processes) and restores all hidden windows 508 before it terminates 509.

FIG. 8 shows an example of an alert screen that is presented upon detection of a process that is not approved according to the list of approved processes 37.

It should be noted that some programs may be included in the list of approved programs 37 permanently and in a way that makes it impossible for an administrator to remove them. Such programs may include programs that are depended on by the system or that are used by other programs that by definition are secure.

The alert service 33 preferably hides windows using the same method as the window hiding sub-component described above, but keeping its own list of hidden windows and suspended processes 38 because if the administrator decides to resume the process, the windows that were hidden by the alert service 33 should be restored to the screen. A number of design options are, however, available within the scope of the present invention.

It should be pointed out that the flowchart illustrates a simplified sequence of events in a preferred embodiment of the invention. Often several of the events illustrated may take place simultaneously, several received commands may be processed in parallel etc. As an example, the alert service 33 just described will not stop receiving and processing new commands while it is processing one that has already arrived. Specifically, received notifications or stop commands will be processed as they arrive, even if the service is already e.g. waiting for user input 505 regarding a previously received notification.

The alert service 33 will preferably, in a Windows type environment, be implemented as a global hook (WB_CBT) that can utilize the following notifications: HCBT_ACTIVATE, HCBT_CREATEWND, HCBT_DESTROYWND, HCBT_MINMAX, HCBT_MOVESIZE, HCBT_SETFOCUS, HCBT_SYSCOMMAND. It will preferably be implemented as a small DLL file.

Alternatively, the alert service 33 could be based on a timer and enumerate, using the EnumWindows API, all existing windows from time to time, e.g. every 300 milliseconds, in order to detect windows belonging to insecure programs.

Instead of suspending the thread of a window that is about to become active, the alert service may simply hide the window as it is about to appear, using one of the methods described, and alert the administrator. Other alternatives, such as automatically terminating the relevant process or suspending it without alerting the administrator, are of course also possible as a matter of design choice.

Reference is now made to FIG. 9, which shows a flow chart illustration of the function of the last of the security shield sub-components, the desktop guard 34. The desktop guard 34 is designed to monitor the secure desktop 40 (described below) and detect situations where it terminates abnormally or hangs. If such a situation occurs, the desktop guard 34 restarts the desktop so the user can continue interacting with the secure environment.

The secure desktop 40 is a rather sophisticated program with a rich user interface. It acts very much like a Windows Shell, communicating with running applications and with the user. Because of this, situations may occur that lead to catastrophic failures, caused for instance by bugs in the secure desktop 40 itself, misbehavior of other applications or unforeseen user input. In such a case the operating system may terminate the secure desktop process, or the desktop threads may be deadlocked by the system or by other applications, in which case the secure desktop will hang. In either case, the desktop guard 34 is designed to resolve the situation.

After the desktop guard 34 is started 600, it waits for a timer notification or a stop command 601. If it receives a stop command 602, it will terminate 603. Until this happens, each time it receives a timer notification it checks to see if the secure desktop process exists 604. In the exemplary embodiment on a Windows based system, this can be performed using the IsWindow API with a handle to the secure desktop window as a parameter. If the secure desktop does not exist, the desktop guard restarts the desktop 605 and waits for the next timer notification or a stop command 601. If the desktop process does exist, the desktop guard 34 checks to determine whether the desktop is running normally or if it hangs 606. This can be done using the SendMessageTimeout API. If the desktops hangs, the desktop process is terminated 607 and then restarted 605 and the desktop guard 34 starts waiting for the next timer notification or a stop command 601.

The desktop guard 34 is preferably implemented inside the security shield 30 executable. Many alternatives exist as to how the details of the desktop guard 34 can be implemented. One example would be to use the GetExitCodeProcess API to detect termination of the secure desktop.

Returning now to FIG. 2, the secure desktop 40 presents the user with an environment where he or she is free to access and interact with programs and resources that have explicitly been defined as secure. The desktop is therefore preferably implemented as a graphical user interface (GUI) that is easy to use, that enables the user to start and use secure programs and that gives the user access to files and folders that belong to the user, but not other files or folders. In addition the secure desktop should provide an administrator (a parent or a master user) with an easy way of configuring the user environment and manage users.

The secure desktop 40 is preferably implemented as a standalone application that uses a number of DLL files. The desktop 40 will in many ways look similar to other GUIs such as the Windows Shell.

The main sub-components of a preferred embodiment of the secure desktop is a security manager 41, a program list 42, a file system browser 43 and administrative tools 44. In addition the secure desktop has access to a list of restricted features 45 and administrative settings and data. During normal operation, the file browser has only access to files and folders 46 belonging to the current user.

The security manager restricts a user's access to protected resources and features, while it allows an administrator to have full access. The security manager 41 maintains the restricted features list 45. This list is a list of features to which an administrator may grant access individually for each user. Such features may e.g. include access to printers or to the Internet. Certain features, such as access to the system menu, is restricted unconditionally. It should be noted that the security manager 41 does not handle access to possibly harmful programs, but restricts access to other resources that are not considered insecure, but that may be restricted for other reasons.

When a user tries to access a restricted feature, the security manager 41 may prompt for an administrator password, and if the password is correct, access is granted. In this way a parent may leave a child to work alone on the computer but e.g. make sure that the printer is only used when the child is supervised.

The security manager 41 is preferably implemented as a DLL module that can be shared by many applications. In this way any application can check whether a user is authorized to access certain features, and applications can also easily be designed to add their own additional features to this list 45.

The secure desktop 40 also includes a secure program list 42. This is a list of programs that are approved by the administrator or included during the design of the secure environment. The program list 42 is preferably implemented as a file system folder containing shortcuts to program files. Enabled programs may then easily appear to the user as a grid of program icons on the desktop, as well as a collection of program icons in a folder accessible from the desktop. The list may also be implemented as a file or as a list of entries in the Windows Registry. When a user starts one of the programs in the list of secure programs 42, the secure desktop 40 registers this program in the list of approved processes 37. In this way the alert service 33 in the security shield 30 will not interrupt it by suspending it and asking for the approval of an administrator.

The secure desktop 40 preferably also includes a file system browser 43 that provides the user with access to files and folders that belong to the user. Since a majority of computer programs will let a user save data to files, it is necessary even for an unsophisticated user like a small child, to be able to relocate and open such file, provided that it is stored in an area to which the user has access and that it can be opened by a secure program. In order to maintain security, the user will only be able to access files stored in pre-defined folders, and the user may not even know where those folders are located.

Finally, the secure desktop 40 should allow access to a number of administrative tools 44 for configuring the secure environment and manage users. In a preferred embodiment, these include assigning and changing the administrator password, adding or deleting users, setting and changing user settings, setting user access rights, defining a start up policy, add keystrokes or keystroke combinations to the list of restricted keystrokes 35, configure security shield alerts 37 and configure the list of secure programs 42.

The various settings are preferably stored in files 47 or in the Windows Registry, and they are changed through the use of wizards, small programs that ask specific questions and configures the settings files in accordance with the administrators response to these questions. As soon as an administrator password is set, only the administrator can access the administrative tools.

FIGS. 10a-c shows an example of how the administrative tools may look from a user point of view. FIG. 10a is a dialog box for a User Settings Wizard, more particularly a dialog window showing a list of features that may be included or excluded from the restricted features list 45.

FIG. 10b shows the administrator dialog box for adding programs to the list of secure programs 42. After selecting a program in this dialog box, the administrator will be prompted to set additional options for this particular program in another dialog box, shown in FIG. 10c.

Even if the present invention has been described with reference to a specific implementation on a specific operating system, it should be emphasized that the invention is not limited to these examples. The invention can be implemented on other operating systems or technology platforms, and in that case the various APIs and other specific details of the examples described here would have to be replaced with adequate functionality of the alternative operating system.

Furthermore, it should be pointed out that there are a number of ways to detect or set conditions and variables, exchange data between processes etc., and that the invention is not limited to those suggested in the examples. Any data or file structure described is likewise intended as examples, as are the separation of components or functionality into separate executable files or separate programs.

The invention includes the method for limiting access to a computers resources as well as a computer system programmed to perform the method according to the invention. The invention may be implemented as computer program code instructions that enables a computer to operate according to the invented method when installed on a such a computer. Such program code may be stored on a storage medium such as floppy disks, CD-ROM, DVD or other magnetic or optical storage media, or it may be carried as a propagated signal.

In view of the many possible implementations to which the principles of the invention may be applied, it should be recognized that the implementations described above are only examples and should not be understood as a limitation on the scope of the invention. Rather, the scope of the invention is defined by the following claims.

1. Method for limiting access to a computer's resources to a number of predefined secure programs and resources, comprising
disabling predefined keyboard input from a keyboard or similar input device in order to prevent input that starts or interacts with insecure programs or accesses insecure resources;
preventing user interaction with insecure programs or resources by making all windows associated with already running programs incapable of receiving input from user input devices; and
generating a user interface to be presented on screen, said interface presenting the user with representations of computer programs and resources that are defined as secure.

2. The method of claim 1, wherein said windows associated with already running programs are made incapable of receiving input from user input devices by being removed from the screen of a display device connected to the computer.

3. The method of claim 1, wherein said windows associated with already running programs are made incapable of receiving input from user input devices by being disabled.

4. The method of claim 1, wherein the disabling of predefined keyboard input is performed by monitoring all input from said input device on a system level and preventing keystroke information from being passed on if it is defined as blocked.

5. The method of claim 4, wherein the monitoring is performed by a systems wide keyboard hook installed on the computer system.

6. The method of claim 4, wherein the monitoring is performed by a driver installed in the keyboard driver chain.

7. The method of claim 2, wherein the removal of all windows is performed by calling a system function that removes each window from the display, and registering each window hidden in this manner by obtaining unique identifiers for each window by calling a system function to obtain such identifiers and entering said identifiers in a list of identifiers.

8. The method of claim 2, wherein the removal of all windows is performed by defining a new window and relocating all existing windows to this window by defining a relationship between said new window and said existing windows that only allows said existing windows to be shown inside said new window, removing said new window from the display, and registering each window hidden in this manner by obtaining unique identifiers for each window by calling a system function to obtain such identifiers and entering said identifiers in a list of identifiers.

9. The method of claim 1, further including
monitoring the system in order to detect windows that are about to be displayed on the screen, checking if any window detected in this manner belongs to a process or a program that is previously defined as secure, and if not, hiding such a window before a user can interact with it, and/or suspending the process to which such a window belongs.

10. Computer program product capable of performing the method according to one of the claims 1 to 9.

11. Computer program product according to claim 10, carried on a computer storage medium readable by a computer.

12. Computer program product according to claim 10, carried by a propagated signal.

13. Computer program product according to claim 10, installed on a computer system.

14. Computer system capable of operating in a secure mode that provides access only to a number of predefined secure programs and resources, comprising
a keyboard filter module installed on the system and capable of disabling predefined keyboard input from a keyboard or similar input device,
a window interaction disabling module installed on the system and capable of disabling interaction between a user input device and insecure programs or resources by making all windows associated with already running programs incapable of receiving input from user input devices; and
a graphical user interface module that generates representations of computer programs and resources that are defined as secure for representation on the display.

15. Computer system according to claim 14, wherein the window interaction disabling module is a window hiding module that is capable of hiding all windows representing already running programs from a display device associated with the computer system.

16. Computer system according to claim 14, wherein the window interaction disabling module is a module that is capable of disabling all windows associated with already running programs.

17. Computer system according to claim 14, wherein the module for disabling predefined keyboard input is a system wide keyboard hook installed on the system.

18. Computer system according to claim 14, wherein the module for disabling predefined keyboard input is a driver installed in the keyboard driver chain.

19. Computer system according to claim 15, wherein the window hiding module is a software module that is set to call system functions that will remove each window from the display, call system functions that will identify each such window uniquely, and register all such windows in a list of such identifiers.

20. Computer system according to claim 15, wherein the window hiding module is a software module that is set to define a new window and relocate all existing windows to this window by calling system functions that define a relationship between said new window and said existing windows that only allows said existing windows to be shown inside said new window, calling system functions that remove said new window from the display; call system functions that will identify each such window uniquely, and register all such windows in a list of such identifiers.

21. Computer system according to claim 14, further including an alert service software module that is set to monitor the system in order to detect windows that are about to be displayed on the screen, check if any window detected in this manner belongs to a process or a program that is previously defined as secure, and if not, hide such a window before a user can interact with it, and/or suspending the process to which such a window belongs.
